(19) United States
(12) Patent Application Publication
(10) Pub. No.: US 2005/0160425 A1
(43) Pub. Date: Jul. 21, 2005

(54) Limitation of the response time of a software process

(75) Inventors: Rainer Falsett, Babenhausen (DE); Reinhard Seyer, Rodgau (DE); Christian Siemens, Wolfsburg (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Munchen (DE)

(21) Appl. No.: 10/504,931

(22) PCT Filed: Jan. 24, 2003
(86) PCT No.: PCT/EP03/00721

(30) Foreign Application Priority Data
Feb. 18, 2002 (DE) 102 06 865.8

(51) Int. Cl. G06F 9/46

(52) U.S. Cl. 718/100

(57) ABSTRACT

A method and a device by means of which the response time of a software process is limited to a predetermined maximum response time is provided. The response time is the sum of latency time (period between triggering event and start of the process) and execution time. The software process is, for example, an interrupt service routine which is triggered by an interrupt request. According to the invention, the software process is subdivided into a number of partial processes which in each case supply a result. If the software process is terminated because the maximum response time has been reached, the result of a previously selected partial process is used as the final result of the process. This partial process is, for example, the one completely executed as the last one.

### BACKGROUND AND SUMMARY OF THE INVENTION

This application claims the priority of German patent application DE 102 06 865.8, filed Feb. 18, 2002 (PCT International Application No. PCT/EP03/00721, filed 24 Jan. 2003), the disclosure of which is expressly incorporated by reference herein.

The invention relates to a method and a device for limiting the response time of a software process to a predefined maximum response time.

A software process is understood to be a process which is executed by a data-processing device and yields a final result. The data-processing device is, for example, a workstation computer, a controller or a controlling device in a motor vehicle and comprises at least one processor for executing program instructions. Such a software process calculates, for example, output signals in dependence on input signals, activates or deactivates devices, generates an output on a peripheral device, e.g. a printer or a screen, or reads data from a file or from a databus into a temporary memory of the process. When a software program is running, a number of software processes are frequently started. The software process can be executed jointly with other software processes in a multi-process-capable operating system, e.g. UNIX, and/or a multi-process-capable runtime environment e.g. Java. Such processing of a number of processes is frequently called “preemptive multi-tasking”. Some such software processes are then called “processes” and others “threads”. The generic term used for “processes” and “threads” is sometimes “tasks”. As used herein, the term “software process” will include “processes”, “threads” and “tasks”.

A special type of software processes is triggered by certain interrupt signals, often called “interrupt requests” IRQs, or interrupts, for short. Such a software process produces a predefined response to a triggering event, e.g. the occurrence of a device fault or a request for immediate termination of any currently unimportant further software processes and other sequences on the data-processing device. In most cases, this sudden event acts on the data-processing device from outside and suddenly. An example of an event which does not act from outside is a division by zero, which is preferably responded to by an exception processing program but not by an interrupt processing program. In the following description, a software process triggered by an interrupt signal will be called interrupt service routine (ISR). For each of the interrupt signals provided, an interrupt service routine is typically allocated.

The latency time of a software process is understood to be the period which elapses between the event triggering this software process and the beginning of the execution of the software process. In the case of an interrupt service routine, the latency time is the period between the arrival of the interrupt signal at the data-processing device and the start of the interrupt service routine which is allocated to the interrupt signal. The period between the beginning and end of the execution of the software process is called the execution time. The sum of latency time and execution time is called the response time of the software process. When the operating speed of the data-processing device and the structure of the software process are known, an upper limit for the response time of the process can be specified for the case where the execution is not interrupted, e.g. by unexpected events.

In practice, however, such events can be expected at any time, which in known devices and methods extend the response time in an unexpected manner or lead to the software process being terminated without result. This is particularly true in the case of safety-critical applications, e.g. in means of transport or in the monitoring of production processes, where it is demanded that the data-processing device can execute certain software processes in real time. This requirement means that the response time of a software process will not exceed a predefined upper limit even when unexpected events occur. This predefined upper limit will be referred to herein as the maximum response time. Adhering to the maximum response time is important, particularly when the software process is an interrupt service routine in which an interrupt signal corresponds to a safety-critical event which has occurred suddenly.

Responsive systems are understood to be real-time-capable systems which yield a result (“response”) after the predefined maximum response time has elapsed. It is particularly desirable to have a method and a device for making a software process into a component of a responsive system.

German patent document DE 32 43 760 C2 discloses a device for monitoring a program run with the aid of a time monitoring device. The time monitoring device triggers a graduated response when a predetermined first period has elapsed without a message about the complete processing of the program having arrived from a processor. First, a signal is generated which triggers an interruption of the execution of the program (software interrupt) and restarts the program or continues it at a defined place. After a second period has elapsed, a hardware reset is triggered which results in a restart of the program sequence. After a third period has elapsed, the processor is deactivated and/or an alarm is triggered.

German patent document DE 32 43 760 C2 does not disclose the result of the program which has been produced after one of the possible graduated responses has been triggered. If a restart is triggered, the terminated program run will not yield any defined result at all. It is possible that the processing is continued at a defined point in the program. In this embodiment, it is not possible to guarantee a maximum response time of the program.

German patent document DE 44 46 286 C1 discloses a responsive, and thus real-time-capable and error-tolerant system with function modules. A maximum processing time is allocated to each function module. The maximum response time of the system to an input signal is determined by a timing module. The maximum response time of a system configured with such function modules can be predicted even before it is taken into operation.

German patent document DE 44 46 286 C1 does not disclose how this response time is adhered to even in the case of disturbances and other unexpected events. That is to say, such events, e.g. the failure of a process, can lead to a function module not supplying a result within the associated maximum processing time as specified and other function modules needing this result not being able to begin their work. However, safety-critical systems, in particular, must yield a useable result within a predetermined response time even in the event of a failure.

German patent document DE 43 29 872 A1 discloses a monitoring device for a processor executing a software program. The processor can be switched from active mode into a rest mode and vice-versa. The execution of the program is continued after an interruption due to switch-over to rest mode and later switch-over to active mode, at the point at which the execution was interrupted. The monitoring device sends an interrupt signal to the processor to switch it into active mode. It is informed about the continuation of the program execution by a trigger signal. If the execution of the program has not ended after a predetermined period, the execution is terminated and the processor is restarted (“reset”). This monitoring device cannot predict what result the program will yield when its execution is terminated due to the period being exceeded.

From German patent document DE 35 44 079 C2, a method for processing interrupt signals and from German patent document DE 35 44 079 A1 a computer with at least one predefined interrupt service routine are known. As soon as an interrupt signal is registered, the currently running main program is interrupted and, instead, the interrupt service routine is started. Further requests by additional interrupt signals are blocked for a defined period, i.e. further interrupt service routines, e.g. from the same source of interrupt signals, cannot be executed within the defined period. After the period has elapsed, the blocking of the requests by interrupt signals is canceled. A method comprising these steps is described in claim 1 of German patent document DE 35 44 079 C2. In German patent document DE 35 44 079 C2, the blocking for a defined period is implemented by means of a timer which is started together with the interrupt service routine. According to one embodiment, it is provided that further requests by additional interrupt signals arriving during the period are deleted.

The method disclosed in German patent document DE 35 44 079 C2 ensures that within the predetermined period, no further interrupt signal can lead to the execution of the interrupt service routine being interrupted or delayed. However, it is not possible to ensure that the interrupt service routine ends with a useful result after the period has elapsed.

U.S. Pat. No. 5,257,357 discloses a data-processing device comprising a number of modules which produce interrupt signals. A selection logic receives interrupt signals as input signals and is capable of allocating altered priorities to the interrupt signals depending on corresponding adaptation signals. Using this selection logic, a user can allocate a higher priority to certain interrupt signals. From the signals, which are changed if required, a processing logic generates a vector of interrupt signals which is sent, e.g., to a processor for executing interrupt service routines. This relieves the processor of identifying interrupt signals and distinguishing or classifying these with respect to their priorities by itself. It is not disclosed how the processing of a first interrupt service routine with lower priority is continued when a second signal having a higher priority arises and because of it the first interrupt service routine is interrupted or terminated.

German patent document DE 199 27 657 A1 discloses a method for preventing the uncontrolled propagation of software errors and for enabling a number of software processes to run independently of one another on a processor. According to the disclosed method, a program memory is subdivided into individual memory areas. These memory areas are permanently allocated individual memory modules and the allocation cannot be changed even in the case of a fault. The program modules are allocated fixed maximum execution times the maintenance of which is monitored. Furthermore, the running program cannot influence the time monitoring even in the case of a fault. In the case of a fault, an interrupt signal then generated will trigger an emergency program (interrupt service routine) for dealing with the fault.

The method disclosed in German patent document DE 199 27 657 A1 requires fixed maximum processing times to be predefined for the program modules and to be stored in an allocation table. This requires good knowledge of the program modules, their operation and the execution time to be expected. Furthermore, additional memory and computing capacities must be provided for the allocation table and its evaluation. Also disclosed is a response to the occurrence of an internal error in the software process, e.g. to one of the available memory areas being exceeded, to an endless loop or to a division by 0. However, it does not disclose how the response time of the software process is maintained when external events occur, that is to say those which are not caused by the execution of the software process itself.

European patent document EP 0 717 361 A2 discloses a procedure for making the response time of an interrupt service routine predictable. A set of possible events which can delay the execution of an interrupt service routine is identified in advance. Two periodically recurring time intervals are implemented with the aid of two timing elements: a first time interval in which the execution of an interrupt service routine can be delayed by events, and a second time interval in which the interrupt service routine is executed without interruptions. During the second time interval, all events arriving which can delay the execution are blocked and only readmitted after the interrupt service routine has been completely executed.

The procedure disclosed in European patent document EP 0 717 361 A2 guarantees only that a maximum response time is maintained in the second time interval but not during the entire operating time of the data-processing device. In addition, all possible delaying events must be identified in advance. This is associated with expenditure. If an event is overlooked, occurs unexpectedly, in a different form, or incompletely, the desired effect may not occur.

U.S. Pat. No. 6,085,218 discloses a method for monitoring the execution time of a software process in a multi-process runtime environment. The execution cycles in which an individual processor executes the software process are counted. Their lengths depend on the clock time of the processor. When the number of execution cycles reaches a predetermined upper limit, the execution of the software process is preferably terminated. Counting of the execution cycles is interrupted when an interrupt signal triggers an interrupt service routine having a higher priority. The number of execution cycles reached is preferably stored and the execution of the software process is continued after the interrupt service routine has been executed completely.

U.S. Pat. No. 6,085,218 does not disclose which result of the software process is used for processing when its execution is terminated, e.g. because the predetermined upper limit has been reached. The only way out is to work without a result of the software process which is often unsatisfactory or can lead to unpredictable results of a higher-level software system.

The invention is based on the object of the software process ending after a predetermined response time, at the latest, and, even after a termination, yielding a result which is useable in spite of the termination. Furthermore, the ensuring should require little additional expenditure.

The invention guarantees that, under all circumstances, the execution of the software process is ended after the maximum response time has elapsed. The software process will still yield a predictable and best-possible final result under the circumstances even if its execution is terminated.

The real-time-capable methods of the prior art often require elaborate calculations in which the worst case is assumed (worst case calculations). Apart from the expenditure for the required modeling and the calculations, the disadvantage is that the guaranteed response time is often very high. The method according to the invention does not require any worst case calculations. It is sufficient to determine the response times of the partial processes when there are no interruptions. The invention guarantees a shorter response time, within which the final result is yielded when the software process has been executed completely or the result of the selected partial process. The method is, therefore, suitable for responsive systems.

Due to the invention, it is not required to considerably overdimension the data-processing device for the sole purpose of maintaining the predetermined maximum response time and providing, for example, additional processors for interrupt processing.

A further advantage of the invention is realized when the maximum response time has elapsed without the software process having been executed completely to its end. In this situation, methods of the prior art will yield either no result at all, continue the execution at a later time or begin only at that point in time to yield an approximation result or an intermediate result. This determination is time consuming and there is scarcely any available computing time, especially after the maximum response time has elapsed.

Due to the invention, in contrast to known methods and devices, it is possible, but not required, to block the execution of further similar software processes for a defined period.

The invention also saves workload in the implementation and computing expenditure for the execution of the software process and for communication with other processes. In the software process itself fewer special processes and responses to external events need to be provided, or none at all, and corresponding conditions and case distinctions do not need to be checked at execution time. Instead, the process responds automatically to external events in a preferred embodiment. Particular events trigger predefined interrupt signals with associated interrupt service routines. If such an event occurs during the execution of the software process, the software process is interrupted and the interrupt service routine allocated to the event is started. The response time of the interrupt service routine is added to the response time of the software process. A timing element for monitoring the maximum response time continues to run. If the maximum response time of the software process is exceeded due to the execution of the interrupt service routine, the result of the partial process selected according to the invention is automatically used as final result, without special processing. Furthermore, this interrupt processing does not need to be taken into consideration during the implementation of the software process.

In an alternative embodiment, the response time of the interrupt service routine is not added to the response time of the software process if the interrupt service routine has a higher priority than the software process. A timing element for monitoring the maximum response time is stopped. In this case, the maximum response time of the software process can be exceeded. This is permissible in some applications. It is a further advantage of the invention that these two different reactions, namely termination or continuation in the case of the time being exceeded due to an interrupt service routine, can be configured in a very simple manner, namely e.g. by corresponding configuration of the monitoring timing element.

During the execution of the software process, the final result is produced, for example, iteratively, i.e. in steps, by the software process. Each partial process yields an approximation result for the final result. After a termination, the partial process which was the last to be completely executed before the termination is selected. The approximation result of this partial process is used as the final result of the software process in the case of the termination. For example, the approximation result of each partial process differs from the final result by a predetermined limit, e.g. 1 mm, at the most, and each approximation result is closer to the final result than the previous one. In this embodiment, an upper limit for the deviation between the approximation result after termination and the final result which would have been calculated if the software process had been executed completely is known automatically and without additional expenditure.

In the case of the iterative production of the final result, each process preferably uses the result of the partial process previously executed, i.e. the preceding partial process, as an input value. The partial process preferably produces a better approximation result than the preceding partial process, i.e. one with less deviation from the final result. In one embodiment, the calculated approximation results are successively stored in the same memory. An approximation result overrides the previously calculated approximation result. After a termination, this memory is read out and its contents are used as final result. This embodiment is error-tolerant against, for example, sudden failures of a processor which executes the partial processes and only requires a single additional memory.

Preferably, a default value for the final result of the software process is determined in advance or an action which can be performed rapidly, e.g. switching-off devices or terminating other software processes, is executed. This default value is, for example, a constant or a value which can be calculated rapidly and which depends on a parameter established before the start of the software process. The default value can be a preferred value, a starting value for an iteration or a logical preset value. A default value determining partial process comprises a triggering of the rapidly performed action or the determination of this default value, for example by rapid calculation or reading-out of a memory in which the constant is stored. For example, this default value determining partial process is performed first. This embodiment has the advantage that, as a rule, a result of a partial process is available very quickly, namely when the determining of the default value or triggering of the action requires little time in comparison with the execution time of other partial processes. As a result, a good final result is produced even in the case of a very premature termination of the software process. This embodiment is particularly advantageous if, apart from the maximum response time, a maximum emergency response time is additionally predetermined. Whereas the maximum response time is the period up to the complete execution of the software process, the maximum emergency response time describes the latency time with addition of the period within which at least one first emergency response is completely executed. The default value determining partial process is preferably defined as emergency response in such a manner that it is terminated within the maximum emergency response time.

In contrast, the another embodiment provides for the first partial process to be executed when the software process is terminated because the maximum response time has almost elapsed. The termination is performed in time so that the first partial process can be executed after the termination. After the termination, the first partial process provides the default value which is used as final result of the software process.

Maintenance of the maximum response time can be monitored by means of hardware or software. Preferably, at least one hardware component is used, e.g. a timing element which can be implemented by simple hardware components. The invention then has the additional advantage that the monitoring requires little additional hardware.

Implementation by hardware, particularly by means of a timing element, is the preferred way of ensuring that the entire response time is actually monitored and limited, and not just the execution time. The period preferably begins with the arrival of a signal which triggers the software process, e.g. an interrupt signal. If, in contrast, the response time is monitored by means of instructions of an operating system, a certain time delay passes until the operating system registers the request for triggering the software process and has accepted it into its priority list. This time delay cannot be monitored and thus taken into consideration and limited. If it is only the triggered software process which allows the period to begin, only the execution time but not the latency time could be monitored and limited. The latency time can be unpredictably long, e.g. due to the occurrence of other software processes having higher priority.

Other objects, advantages and novel features of the present invention will become apparent from the following detailed description of the invention when considered in conjunction with the accompanying drawings.

### BRIEF DESCRIPTION OF THE DRAWINGS

In the text which follows, the invention will be explained by means of two exemplary embodiments shown in the drawings, in which:

FIG. 1 shows the configuration of an engine control device which calculates the ignition time; and

FIG. 2 shows the configuration of a monitoring device for interrupt servicing.

### DETAILED DESCRIPTION OF THE DRAWINGS

The invention will be initially described using an engine control device 10 as an example. This engine control device 10 recalcualates the time of ignition during each revolution, i.e. during each complete operating cycle of the engine. Reaching the correct ignition time lowers the gas consumption and the emission of pollutants. Accordingly, the correct ignition time may contribute to meeting legal requirements with regard to environmental compatibility and enhances the economic viability of the motor vehicle and thus the competitiveness of the manufacturer.

Methods of the prior art only recalculate the ignition time during each revolution up to a certain predetermined engine speed. If the engine speed increases above the predetermined limit, the ignition time is only recalculated during each second revolution. For the intermediate revolutions, the last value calculated is reused. As a result, the optimum ignition time may not be reached. If too low a limit is predetermined for the motor speed, there is no recalculation even though computing time is still available. If too high a limit is predetermined, the calculation may have to be terminated because no further computing time is available.

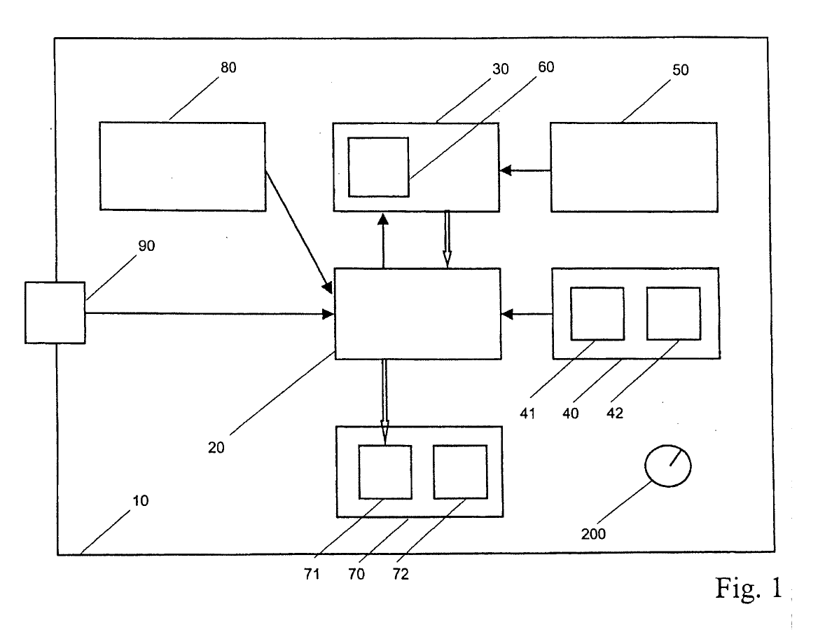

FIG. 1 illustrates an exemplary configuration of an engine control device 10 in which the invention is used. The engine control device 10 comprises an execution processor 20 which, among other things, redetermines the ignition time during each revolution. If required, the execution processor 20 procures the required data about the current state of the vehicle, e.g. the engine speed and the traveling speed, from an internal data memory 80 or via an interface 90 to a databus in a vehicle which connects the engine control device 10 to, among other things, other control devices. The calculation of the ignition time essentially consists of executing a calculation program. The executing software process thus comprises the execution of this calculation program. The calculation program is stored in a first program memory 40 for calculation programs.

FIG. 1 illustrates data and signal flows by means of thin arrows and writing or adjusting interventions by means of thick arrows.

Furthermore, the engine control device 10 comprises a result memory 70. The result memory 70 is a data memory in which the final result, such as the calculated ignition time, is stored. This result memory 70 is subdivided into two partial data memories. In the first partial data memory 71, the calculated final result is stored. In the second partial data memory 72, the final result of the calculation during the previous revolution, that is to say the last ignition time used, is stored.

The execution processor 20 successively executes the partial processes. After having been executed, each partial process yields a result. This result is written into the first partial data memory 71 by the execution processor 20, and a previously stored result is preferably overwritten.

The execution processor 20 determines the correct ignition time preferably iteratively, i.e. in steps. The first partial process calculates a starting value for the iteration. This starting value is, e.g. a generally valid preferred value or also the final result of the previous calculation, i.e., the last ignition time. Each calculation step is a partial process of the software process. The calculation steps, and thus the partial processes, are executed successively. Each calculation step yields a result which is more accurate than the result of the previous calculation step. The result of the previous calculation step is preferably used for executing a calculation step apart from the first calculation step. For the first calculation step, the starting value calculated in the first partial process can be used as input variable. As illustrated in FIG. 1, the first program memory 40 for calculation programs includes a first partial program memory 41 for the first partial process by means of which the starting value is calculated, and a second partial program memory 42 for the calculation step which is executed repeatedly. The result of each calculation step is stored in the first partial data memory 71.

The software process itself preferably comprises a termination criterion, e.g. the number of calculation steps. At the end of the calculation, the final result, namely the ignition time, is stored in the result memory 70 and is used for subsequent operating steps of the engine control device 10. These subsequent operating steps and devices for these are not shown in FIG. 1. However, it is also possible that the execution of the software process always completely occupies the predetermined response time and is only terminated by the monitoring device 30 in the manner described as follows.

According to the invention, the monitoring device 30 ensures that the predetermined response time is maintained. The monitoring device comprises a timing element. At the instant at which the latency time for calculating the ignition time begins, a counter of the timing element is set to a predefined value. The beginning of the latency time is, for example, the time at which the engine control device 10 generates the instruction for calculating the ignition time. The predefined value is preferably inversely proportional to the engine speed. The counter is decremented by a value of 1, preferably with each cycle generated, for example, by a system clock 200 of the engine control device 10. The operation of the timing element is terminated as soon as the execution of the software process is concluded, and the calculated final result is stored in the first partial data memory. For this purpose, the execution processor 20 preferably transmits a corresponding end signal to the monitoring device.

At the instant at which the counter of the timing element reaches the value 0 without the monitoring device having received the end signal from the execution processor 20, it is certain that the predetermined period has elapsed. This may have occurred, for example, because other processes with higher priority occupied a considerable proportion of the computing time of the execution processor 20 or because it is provided that the partial process completely utilizes the predetermined response time. According to the invention, the monitoring device triggers an interrupt service when the counter reaches the value 0. For this purpose, it calls up an interrupt service routine which is stored in a second program memory 50 for interrupt service routines.

This interrupt service routine preferably first decides the manner in which the value now used as ignition time is calculated. For this purpose, a decision is preferably made between the following alternatives:
the result of the partial process which was executed last is used as the current ignition time. This result is stored in the first partial data memory 71 of the result memory 70;
The previous ignition time is determined and reused as current ignition time; and
A preferred value for the ignition time is determined and used as the current ignition time.

During the construction of the engine control device 10 that one of these three alternatives is always executed. However, the decision is preferably only made at the time of the interrupt service. One embodiment provides that the execution processor transmits an intermediate signal to the monitoring device as soon as it has executed a predetermined number of partial processes and stored the result of the partial process executed last in the first partial data memory 71. For example, the intermediate signal is transmitted as soon as the execution processor 20 has executed the first partial process and stored the starting value in the first partial data memory 71, or as soon as it has executed the third partial process and thus calculated the starting value and then executed two calculating steps. If this intermediate signal has arrived at the monitoring device before the interrupt service was begun, the result stored in the first partial data memory 71 is used as final result, that is to say as current ignition time, and otherwise the result stored in the second partial data memory 72 is used, that is to say the previous ignition time. According to one aspect of this embodiment, when the intermediate signal is not available a decision is made whether the previous ignition time is reused, or instead a preferred value is determined and used as the current ignition time. This decision can depend on whether significant environmental conditions, e.g. the engine speed, have changed since the calculation of the previous ignition time.

All these embodiments provide for a useable ignition time to be calculated quickly and in a predictable manner. In the calculation program for the ignition time, external results which could delay the calculation of the ignition time do not need to be taken into consideration. Furthermore, it is not necessary to provide in the calculation program the reuse of the previous ignition time in the case of high engine speeds or with high processor loading.

In the second exemplary embodiment, the software process, the response time of which is limited, is itself an interrupt service routine which is allocated to a predefined interrupt signal type (interrupt request). The interrupt signal type is one of M predefined interrupt signal types, M being a natural number. Due to the identification, the M interrupt signal types are preferably distinguished from one another. Furthermore, one of M interrupt service routines is allocated to each interrupt signal type. An interrupt signal of the same type can arrive several times at different times.

Each interrupt service routine in each case preferably comprises a default value determining partial process which determines a default value as described above or triggers an action which can be rapidly performed. Preferably, a maximum emergency response time is additionally predetermined for each interrupt service routine. The default value determining partial process is designed in such a manner that it can be executed within the maximum emergency response time. Furthermore, a minimum repetition time or a maximum repetition frequency is preferably predetermined for each interrupt service routine. The minimum repetition time is the reciprocal value of the maximum repetition frequency.

Preferably, the check described in the text which follows is performed in advance. Let UBP_1, . . . , UBP_M be the M predefined interrupt service routines. Let NRZ(UBP_i) and WZ(UBP_i) be the maximum emergency response time and, respectively, the minimum repetition time of UBP_i (i=1, . . . ,N). These times are preferably specified as multiplies of a predetermined reference time unit, e.g. the reciprocal of the processor or system clock. Then, NRZ(UBP_1)/WZ(UBP_1)+ . . . +NRZ(UBP_N)/WZ(UBP_N) must not exceed a predetermined upper limit. This limit often has the value T*ln 2, where ln designates the natural logarithm and T preferably designates the entire available computing time of the processor. It is also possible to use T itself as the upper limit.

To each interrupt signal type, one of N different priorities is allocated, N<=M also being a natural number. Thus, each interrupt service routine also has one of N priorities. The allocated priority preferably depends on the significance of the interrupt service routine and on the maximum emergency response time—the lower the maximum emergency response time, the higher the priority.

In accordance with one aspect of the embodiment, different priorities are allocated to individual partial processes of an interrupt service routine. Necessary partial processes receive, e.g. the priority of the interrupt signal and other partial processes receive a lower priority.

According to the invention, the interrupt service routines are subdivided into partial processes. One of these is the default value determining partial process. The individual partial processes are preferably defined in such a manner that their execution cannot be interrupted or terminated by interrupt signals.

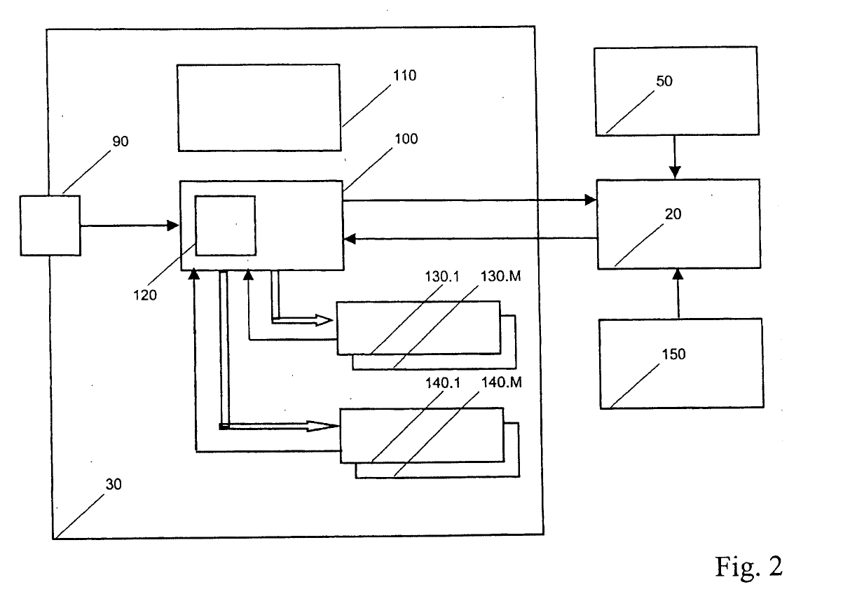

FIG. 2 illustrates an exemplary configuration of a monitoring device 30 which limits the response time of interrupt service routines. The interrupt service routines are executed by an execution processor 20. For this purpose, the execution processor 20 performs a read access to at least one program memory 50 for the interrupt service routines. According to the invention, the interrupt service routines, in turn, are subdivided into partial processes which are preferably executed successively in each case. For example, the source program for each partial process is stored in a separate partial program memory in such a manner that partial processes cannot override partial program memories or data memories of other partial processes. The result of each partial process is stored by the execution processor, as described above, in a result memory 70 which is not shown in FIG. 2.

The maintenance of the predetermined response time, according to the invention, is monitored by a monitoring device 30. This monitoring device 30 also controls the time sequence in which the incoming interrupt signals are processed. It preferably comprises an interrupt request controller 100, a memory 110 for interrupt signals, M blocking time elements 130 and M response time-time elements 140. All 2*M time elements are connected to the interrupt request controller 100; FIG. 2 only shows the connection between the interrupt request controller 100 and two time elements.

For each of the M interrupt signal types, one blocking time element 130 and one response time-time element 140 are provided in each case. These 2*M time elements preferably operate as described above. It is possible to predetermine up to 2*M different periods and to change them by only changing one time element.

The blocking time element 130.i for the interrupt signal type i blocks the execution of an interrupt signal of type i for a predefined blocking time and thus ensures that two interrupt signals of the same type can only be processed with a predetermined repetition frequency, at the most, but not more frequently. In other words: it is ensured that at least one predetermined repetition time elapses as blocking time between two calls of the interrupt service routine for type i. The reciprocal value is the maximum repetition frequency. During this period, the blocking time element 130.i is either in the state “block_store”, “block_ignore”, or “pass”. The three states are implemented, for example, with the aid of a counter and an additional 1-bit register. When changing to one of the states “block_store” or “block_ignore”, the counter is set to a predefined value of greater than 0 and is in each case decremented by one in a system cycle predetermined by a system clock 200. When the counter assumes the value 0, the blocking time element 130.i is in the state “pass”. By means of the 1-bit register, the states “block_store” or “block_ignore” are distinguished.

The response time-time element 140.i for the interrupt signal type i limits the latency time plus the execution time of an interrupt signal of type i to a predefined maximum response time. When the execution processor 20 executes the interrupt service routine allocated to type i and the predetermined period for the response time has not yet elapsed, the response time-time element 140.i is in the state “active” and otherwise it is in the state “inactive”.

Furthermore, the interrupt request controller 100 preferably comprises a priority memory 120 in which the maximum priority of all interrupt service routines currently executed by the execution processor 20 are stored.

When an interrupt signal arrives, e.g. at an interface 80 to the databus, the interrupt request controller 100 identifies the type of this interrupt signal and the priority allocated to the type and executes at least one of the following steps:
It forwards the interrupt signal to the execution processor 20;
It interrupts interrupt service routines currently being executed by the execution processor 20;
It stores the identification and the time of arrival of the interrupt signal in the interrupt signal memory 110; and
It ignores the interrupt signal.

Which one or which of these four steps are executed by the interrupt request controller 100 depends on the priority of the interrupt signal and on the current states of the two time elements provided for the interrupt signal type.

Let i be the type of the interrupt signal and j the priority allocated to type i. The interrupt request controller 100 carries out the following case distinctions:
If the blocking time 130.i for type i is in the state “block_ignore”, it ignores the interrupt signal;
If the blocking time element 130.i for type i is in a state “block space_store”, it stores the type i identified by the identification and the arrival time of the interrupt signal in the interrupt signal memory 110;
If the blocking time element 130.i for type i is in the state “pass”, the interrupt request controller 100 determines by means of read access to the priority memory 120 whether the execution processor 20 is currently executing an interrupt service routine which has a priority which is higher than or equal to that of type i. If this is the case, it again stores identification and time of arrival in the interrupt signal memory 110. Otherwise, it forwards the interrupt signal to the execution processor 20. The latter executes the associated interrupt service routine for type i; and
If the interrupt request controller 100 forwards the interrupt signal, it at the same time causes the execution processor 20 to interrupt all interrupt service routines having a lower priority and first to execute that for type i.

This embodiment leads to an interrupt signal with priority j always being serviced preferably before one having a priority k (k>j). Two interrupt signals with the same priority are serviced in the order in which they arrive in time.

If required, the interrupt request controller 100 also updates the two time element of type i and the priority memory 120.

Directly after arrival of the interrupt signal of type i, it changes the blocking time element 130.i for type i into the state “block_ignore”. The blocking time element 130.i begins to measure the predetermined blocking time. When it begins to execute the interrupt service routine for type i, the execution processor 20 then sends a corresponding signal to the interrupt request controller 100. The latter then changes the blocking time element 130.i for type i from the state “block_ignore” to the state “block_store”. After the predetermined blocking time monitored by the blocking time element 130.i has elapsed, it is changed from the state “block_store” to the state “pass”. If the blocking time elapses before the execution of the interrupt service routine has begun, the blocking time element 130.i is changed from the state “block_ignore” to the state “block_store” and, after the interrupt service routine has ended, to the state “pass”. This embodiment leads to further interrupt signals of type i being ignored within the latency time of the interrupt service routine for type i and stored in the execution time.

Immediately after arrival of the interrupt signal, the interrupt request controller 100 also changes the response time-time element 140.i to the state “active”. The response time-time element 140.i then begins to monitor the response time. If the execution processor 20 completely executes the interrupt service routine within the predetermined maximum response time, it sends a corresponding signal to the interrupt request controller 100. The latter then changes the response time-time element 140.i for type i to the “inactive” mode. If the time element registers that the predetermined maximum response time has elapsed and it is still in the “active” state, it sends a corresponding signal to the interrupt request controller 100. The latter then changes it into the “inactive” state and sends a corresponding signal to the execution processor 20. The execution processor 20 then terminates the execution of the interrupt service routine for type i and, after the termination, begins a predefined interrupt service. For this purpose, the execution processor 20 preferably performs a read access to a program memory 150 for termination services. As described above, it can consist of determining a preferred value or using the result of the partial process executed last, which is stored in the result memory 70, as the final result of the interrupt service routine for type i.

As soon as the interrupt request controller 100 registers that an interrupt service routine has been executed completely or its maximum response time has elapsed, it updates the priority memory 120 and selects among the interrupt signals stored in the interrupt signal memory 110 having the highest priority. Among several having the same priority, the one having the earliest time of arrival is selected. The entry for the selected interrupt signal is removed from the interrupt signal memory 110 and the decisions and operating steps described above are executed for the selected interrupt signal. The interrupt signal is forwarded to the execution processor 20 or again stored in the interrupt signal memory 110. The latter can happen, in particular, if an interrupt signal of higher priority is being processed. If necessary, the states of the two associated time elements are also updated.

The interrupt request controller 100 can be configured in two different ways: if the execution of an interrupt service routine is interrupted because an interrupt signal of higher priority is serviced with preference, either the response time-time element 140.i is stopped or it continues to run. In the former case, the response time of the interrupt service routine is prolonged for the duration of the further interrupt service routine of higher priority, and in the second case it is not. In the former case, the interrupt request controller 100 interrupts the operation of the response time-time element 140.i and in the second case it does not. As a result, the change between these two operating modes can be implemented in a simple manner.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-21. (canceled)

22. A method for limiting the response time of a software process to a predetermined maximum response time,
the execution of the software processes yielding a final result, and the execution of the software process being terminated at the latest when it has not ended after the maximum response time has elapsed, wherein
the execution of the software process comprises the execution of partial processes, each of these partial processes, after having been executed, yielding a result,
and when the execution of the software process is terminated, a partial process is selected and its result is used as the final result of the software process.

23. The method as claimed in claim 22, wherein the response time of the software process is monitored by a component which is activated when the software process is triggered.

24. The method as claimed in claim 22, wherein in the case of termination, selecting only those partial processes which are completely executed on termination of the execution of the software process.

25. The method as claimed in claim 22, wherein
the partial processes are executed successively in a certain order; and after a termination, the partial process which has been executed completely as the last one is selected.

26. The method as claimed in claim 25, wherein the final result is yielded iteratively by the software process and each partial process yields an approximation result for the final result.

27. The method as claimed in claim 25, wherein the result of each partial process is stored, the result of a preceding partial process being overwritten by the result of a following partial process.

28. The method as claimed in claim 22, wherein at least one of the partial processes is a default value determining partial process by which a default value for the final result of the software process is determined or an action is triggered.

29. The method as claimed in claim 28, wherein the default value determining partial process is selected on termination of the software process.

30. The method as claimed in claim 28, wherein the execution of the software process begins with the execution of the default value determining partial process.

31. The method as claimed in claim 28, wherein the default value determining partial process has a response time which is no longer than a predetermined maximum emergency response time.

32. The method as claimed in claim 31, wherein the execution of the software process is terminated at the latest when the maximum response time up to the maximum emergency response time has elapsed, and the default value determining partial process is executed after termination of the software process.

33. The method as claimed in claim 22, wherein the software process is an interrupt service routine which has been triggered by an interrupt signal.

34. The method as claimed in claim 33, wherein, after a first triggering of the interrupt service routine, another triggering is prevented for a predetermined period.

35. The method as claimed in claim 22, wherein
the software process is executed in a multi-processor system which takes into consideration different priorities for software processes,
a priority is allocated to the software process,
an event triggers a further software process,
a priority is allocated to the further software process which is higher than that of the software process,
and execution of the software process is interrupted after the occurrence of the triggering event.

36. The method as claimed in claim 35, wherein the period during which the execution of the software process is interrupted is added to the response time of the software process.

37. The method as claimed in claim 35, wherein
the further software process is an interrupt service routine and the triggering event is an interrupt request.

38. A device for carrying out the method as claimed in claim 22, the device comprising:
means for monitoring the response time of the software process;
means for executing partial processes;
means for selecting an executed partial process; and
means for yielding a result of the executed partial process.

39. A device for executing a software process which yields a final result, the device comprising:
a processor which executes the software process; and
a monitoring device which monitors the response time of the software process,
wherein the monitoring device terminates the execution of the software process and triggers the execution of an interrupt service routine at least when the execution of the software process has not ended after a predetermined maximum response time has elapsed,
the processor, during the execution of the software process, executes partial processes, each of these partial processes yielding a result after having been executed, the interrupt service routine selects one of these partial processes, and the device uses the result of the selected partial process as the final result.

40. The device as claimed in claim 39, wherein the processor yields the final result iteratively and each result of a partial process is an approximation result for the final result.

41. The device as claimed in claim 40, wherein the device comprises a result memory, the processor stores the result of each partial process in the result memory, and the interrupt service routine reads out the contents of the result memory.

42. The device as claimed in claim 39, wherein the monitoring device comprises a timing element which generates a signal after the maximum response time has elapsed.
